(19) United States
(12) Patent Application Publication
(10) Pub. No.: US 2026/0148910 A1
(43) Pub. Date: May 28, 2026

(54) Movable Terminal Unit Assembly Structure, Push Button Switch having the Same, Controller having the Push Button Switch, and Movable Terminal Unit Assembly Method

(71) Applicant: IDEC Corporation, Osaka (JP)

(72) Inventors: Yuki KAWASE, Osaka (JP); Tetsuya NAGAE, Osaka (JP); Takashi IWAMI, Osaka (JP); Atsushi MATSUMOTO, Osaka (JP); Nobuo HIGUCHI, Osaka (JP)

(21) Appl. No.: 19/119,548

(22) PCT Filed: Aug. 18, 2023
(86) PCT No.: PCT/JP2023/029822

§ 371 Date: Apr. 9, 2025

(30) Foreign Application Priority Data
Oct. 10, 2022 (JP) 2022-162845

(51) Int. Cl. H01H 13/60; H01H 1/30; H01H 3/02; H01H 13/32

(52) U.S. Cl. CPC H01H 13/60; H01H 1/30; H01H 3/022; H01H 13/32; H01H 2003/024

(57) ABSTRACT

The present invention provides an assembly structure of a movable terminal unit that can improve an ease of assembly. In the assembly structure of the movable terminal unit 7, a housing space S is defined by a first wall portion 71 and a second wall portion 72 that are oppositely disposed across a predetermined distance. In the housing space S, a movable terminal 8 is housed and a coil spring 9 is also housed that biases the movable terminal 8 toward the first wall portion 71. The second wall portion 72 is formed with a through hole 72a that the coil spring 9 can pass through. A pressing member 10 is disposed at the through hole 72a that compressive-deforms the coil spring 9. The pressing member 10 includes an outer circumferential surface 10A that makes a sliding-contact circumferentially with a circular inner circumferential surface of the through hole 72a. The pressing member 10 is held at the through hole 72a through an engagement protrusion 72b and an engagement recess 10a that are provided at the inner and outer circumferential surfaces.

### TECHNICAL FIELD

The present invention relates generally to an assembly structure of a movable terminal unit and more particularly to an improvement of its structure for improving an ease of assembly.

### BACKGROUND ART

Japanese utility model registration application publication No. 1979-19969 discloses a movable contact supporting device for supporting the movable contact through a spring in an electromagnetic contactor and the like. In the movable contact supporting device, as shown in line 15, page 3 to line 20, page 4 of the specification and FIGS. 4 to 6, the movable contact supporting body (1) is formed with the vertical groove (10) and the stopper (12) is provided at the opening edge (11) of the vertical groove (10). After the movable contact (4) and the spring (3) are housed in the groove (10), the spring holder (15) is inserted into the groove (10) and engaged with the stopper (12). Both ends of the spring holder (15) are bent and the bent portions (13) of the spring holder (15) sandwich the movable contact supporting body (1).

Japanese utility model registration application publication No. 1977-26171 discloses a contact fitting device in an electromagnetic contactor. In the contact fitting device, as shown in line 17, page 2 to line 18, page 3 of the specification and FIGS. 1 to 2, the vertical groove (2) and the concave groove (3) are formed at the movable frame (1), the engagement portion (4) is provided at the opening end of the vertical groove (2), and the contact (5) is inserted into the vertical groove (2) and the concave groove (3). Subsequently, the coil spring (7) is inserted. Thereafter, the elastic holder (8) is press fit at the opening end of the vertical groove (2) and the protrusion (9) of the elastic holder (8) is engaged with the engagement portion (4) of the movable frame (1).

Japanese patent publication No. 3829963 discloses a movable contact device for a multi-pole switch such as a circuit breaker or an electromagnetic contactor and the like. In the movable contact device, as shown in paragraphs [0010] to [0013] and FIGS. 1 to 3, the groove (21b) is formed at the holder (21) and the engagement protrusion (21c) is formed at the distal end of the holder leg portion (21a). After the movable contact (8) and the contact spring (12) are inserted into the groove (21b), the outside of the distal end of the holder leg portion (21a) is covered by the holder support (22) and the engagement protrusion (21c) of the holder leg portion (21a) is engaged with the slit (22b) of the holder support (22).

### PRIOR ART REFERENCES

### Patent Documents

Patent Document 1: Japanese utility model registration application publication No. 1979-19969 (see line 15 of page 3 to line 20 of page 4, and FIGS. 4 to 6);

Patent Document 2: Japanese utility model registration application publication No. 1977-26171 (see line 17 of page 2 to line 18 of page 3, and FIGS. 1, 2); and

Patent Document 3: Japanese patent publication No. 3829963 (see paragraphs [0010] to [0013], FIGS. 1 to 3).

### SUMMARY OF THE INVENTION

### Objects to Be Achieved by the Invention

In the movable contact supporting device described in the above-mentioned Japanese utility model registration application publication No. 1979-19969, when fitting the spring holder (15) to the groove (10) of the movable contact supporting body (1), the spring (3) is pressed and inserted into the groove (10) with the spring holder (15) tilted diagonally relative to the groove (10), and as the spring holder (15) has passed the stopper (12) the spring holder (15) is returned to its horizontal posture. Thereby, due to the action of the elastic repulsion of the spring (3), the spring holder (15) comes into engagement with the stopper (12) (see page 4, lines 5 to 20 and FIG. 5).

In this way, in the structure of the above-mentioned Japanese utility model registration application publication No. 1979-19969, when fitting the spring holder (15), the spring holder (15) needs to be tilted diagonally in the groove (10) and besides, in the tilted state, the spring (3) has to be inserted into the groove (10) against the elastic repulsion of the spring (3), which worsens an ease of assembly. Moreover, in order to prevent the spring holder (15) from falling out, the stopper (12) is provided at the opening edge (11) of the groove (10) of the movable contact support body (1) and the bent portions (13) is provided at both ends of the spring holder (15), thus making the structure somewhat complicated. Also, due to an installation of the bent portions (13) at the spring holder (15), when the spring holder (15) is tilted diagonally, the bent portions (13) need to be positioned so as to be disposed at both ends of the movable contact support body (1), thus decreasing a work efficiency to worsen an ease of assembly.

In the contact fitting device described in the above-mentioned Japanese utility model registration application publication No. 1977-26171, when fitting the elastic holder (8) to the opening end of the groove of the movable frame (1), the protrusion (9) of the elastic holder (8) needs to be positioned relative to the engagement portion (4) of the movable frame (1) (see page 3, lines 11 to 18 and FIGS. 1 to 2), thus decreasing a work efficiency to worsen an ease of assembly.

In the movable contact device described in the above-mentioned Japanese patent publication No. 3829963, when fitting the holder support (22) at the outside of the distal end of the holder leg portion (21a), the slit (22b) of the holder support (22) needs to be positioned relative to the engagement protrusion (21c) of holder leg portion (21a) (paragraphs [0010] to [0013] and FIGS. 1 to 3), thus decreasing a work efficiency to worsen an ease of assembly.

The present invention has been made in view of these circumstances and its object is to provide an assembly structure of a movable terminal unit that can improve an ease of assembly.

### Means of Achieving the Objects

In an assembly structure of a movable terminal unit according to the present invention, a housing space is defined by a first wall portion and a second wall portion that are oppositely disposed across a predetermined distance. In the housing space, a movable terminal is housed and a biasing member is housed that biases the movable terminal toward the first wall portion. The second wall portion is formed with a through hole that the biasing member can pass through. A pressing member is disposed at the through hole that compressive-deforms the biasing member. The pressing member includes an outer circumferential surface that makes a sliding-contact circumferentially with a circular inner circumferential surface of the through hole. The pressing member is held at the through hole through an engagement portion that is provided at the inner and outer circumferential surfaces.

According to the present invention, the movable terminal and the biasing member that biases the movable terminal toward the first wall portion are housed in the housing space defined by the first and second wall portions. The pressing member is disposed at the through hole of the second wall portion. The outer circumferential surface of the pressing member is in circumferential sliding-contact with the circular inner circumferential surface of the through hole. The pressing member is held at the through hole through the engagement portion of the inner and outer circumferential surfaces. Thereby, when fitting the pressing member to the through hole through the engagement portion, all one has to do is slide the outer circumferential surface of the pressing member circumferentially along the circular inner circumferential surface of the through hole, thus improving an ease of assembly.

An assembly structure of a movable terminal unit according to the present invention includes a housing portion that is open at one end thereof. A movable terminal is housed in the housing portion and a pressing member that biases the movable terminal toward the other end of the housing portion is housed in the housing portion. An opening at one end of the housing portion is sized so that the biasing member can pass through. A pressing member is disposed at the opening that compressive-deforms the biasing member. The pressing member includes an outer circumferential surface that makes a circumferential sliding-contact with a circular inner circumferential surface of the opening. The pressing member is held at the opening through an engagement portion provided at the inner and outer circumferential surfaces.

According to the present invention, the movable terminal and the biasing member that biases the movable terminal toward the other end of the housing portion are housed in the housing portion that is open at its one end, and the pressing member is disposed at one-end opening of the housing portion. The outer circumferential surface of the pressing member is in a circumferential sliding-contact with the circular inner circumferential surface of the opening, and the pressing member is held at the opening through the engagement portion of the inner and outer circumferential surfaces. Thereby, when fitting the pressing member to the opening through the engagement portion, all one has to do is slide the outer circumferential surface of the pressing member circumferentially along the circular inner circumferential surface of the opening, thus improving an ease of assembly.

The engagement portion may be formed of an engagement protrusion extending circumferentially at either one of the inner circumferential surface of the through hole/opening or the outer circumferential surface of the pressing member and an engagement recess extending circumferentially and engageable with the engagement protrusion at either the other of the inner circumferential surface of the through hole/opening or the outer circumferential surface of the pressing member.

The engagement recess may include an insertion slot that allows an insertion of the engagement protrusion, a circumferential movement restrictive portion that restricts the engagement protrusion from moving circumferentially in the engagement recess in an engagement state of the engagement protrusion, and an axial movement restrictive portion that restricts the engagement protrusion from moving axially in the engagement recess.

The engagement portion may be formed of a plurality of engagement portions that are disposed across substantially equal circumferential spacing. Here, the reason why the word “substantially” is introduced is that the spacing does not need an equal spacing in the strict sense and a certain degree of margin of error is permitted.

The pressing member may have a catch portion for rotating the pressing member around a central axis thereof through a rotary tool.

The biasing member may be a coil spring. The pressing member may have a shaft portion that extends in an inside space of the coil spring and that restricts the amount of movement of the movable terminal.

The push button switch according to the present invention includes an assembly structure of the above-mentioned movable terminal unit. The movable terminal is movable along with the push button and the movement of the push button causes the movable terminal to move toward and away from the fixed terminal.

The push button switch may be an emergency stop switch.

The controller according to the present invention includes a push button switch.

In the assembly method of the movable terminal unit according to the present invention, the movable terminal unit includes a movable terminal, a biasing member that biases the movable terminal, and a pressing member of the biasing member. The assembly method is for housing and assembling the movable terminal unit in the housing portion that is open at its one end and to its side. The assembly method comprises the following steps:
i) Inserting the movable terminal into the housing portion from the opening at the one-end or the side of the housing portion and disposing the movable terminal at the other-end of the housing portion;
ii) Inserting the biasing member into the housing portion from the opening at the one-end of the housing portion and making the biasing member contact with the movable terminal; and
iii) Disposing the pressing member at the opening at the one-end of the housing portion, making the pressing member contact with the biasing member to press and compressive-deform the biasing member, and sliding the pressing member circumferentially along the circular inner circumferential surface of the opening at the one-end of the housing portion, whereby the pressing member is held in the opening at the one-end of the housing portion through the engagement portion provided at the inner circumferential surface of the opening at the one-end of the housing and at the outer circumferential surface of the pressing member that corresponds to the inner circumferential surface of the opening.

According to the present invention, firstly, the movable terminal is inserted into the housing portion from the opening at the one-end or the side of the housing portion and disposed at the other-end of the housing portion, and the biasing member is inserted into the housing portion from the opening at the one-end of the housing portion and comes into contact with the movable terminal. Secondly, the pressing member is disposed at the opening at the one-end of the housing portion and comes into contact with the biasing member to press and compressive-deform the biasing member, and the pressing member slides circumferentially along the circular inner circumferential surface of the opening at the one-end of the housing portion. Thereby, the pressing member is held at the opening at the one-end of the housing portion through the engagement portion at the inner circumferential surface of the opening at the one-end of the housing portion and at the outer circumferential surface of the pressing member. In such a manner, when fitting the pressing member in the opening at the one-end of the housing portion, all one has to do is slide the pressing member circumferentially along the circular inner circumferential surface of the opening at the one-end of the housing portion, thus improving an ease of assembly.

### Effects of the Invention

As mentioned above, according to the present invention, when fitting the pressing member in the through hole/opening, since all one has to do is slide the pressing member circumferentially along the circular inner circumferential surface of the through hole/opening, an ease of assembly can be improved.

### BRIEF DESCRIPTION OF THE DRAWINGS

FIG. 1 is a general perspective view of an emergency stop switch (or a push button switch) employing an assembly structure of a movable terminal unit according to an embodiment of the present invention;

FIG. 2 is a front elevational view showing the internal structure of the emergency stop switch of FIG. 1 except for a push button, a hold case, a lock nut and the like, illustrating the movable terminal unit along with a shaft portion and a fixed contact;

FIG. 3 is an enlarged view of a portion of FIG. 2 illustrating an enlarged view of a portion of the movable terminal unit;

FIG. 4 is a perspective view of the movable terminal unit of FIG. 3 as viewed from diagonally below;

FIG. 5 is a bottom plan view of the movable terminal unit of FIG. 3;

FIG. 6 is a front elevational view of the movable terminal unit (FIG. 3) in the upside-down state;

FIG. 7 is a front elevational view of a housing of the movable terminal unit of FIG. 6;

FIG. 8 is a perspective view of the housing of FIG. 7 as viewed from diagonally above;

FIG. 9 is a top plan view of the housing of FIG. 8;

FIG. 10 is a perspective view of a movable terminal, a biasing member and a pressing member that are taken out of the movable terminal unit of FIG. 6;

FIG. 11 is a front elevational view of the pressing member of FIG. 10;

FIG. 12 is a bottom plan view of FIG. 11;

FIG. 13 is a blown-up perspective view of the movable terminal unit of FIG. 6 showing the assembly procedures of the movable terminal unit in time-series manner;

FIG. 14 illustrates the assembly procedures of the movable terminal unit of FIG. 6 in time-series manner;

FIG. 15 illustrates the assembly procedures of the movable terminal unit of FIG. 6 in time-series manner;

FIG. 16 illustrates the assembly procedures of the movable terminal unit of FIG. 6 in time-series manner;

FIG. 17 illustrates the assembly procedures of the movable terminal unit of FIG. 6 in time-series manner;

FIG. 18 illustrates the assembly procedures of the movable terminal unit of FIG. 6 in time-series manner; and

FIG. 19 illustrates the assembly procedures of the movable terminal unit of FIG. 6 in time-series manner.

### BEST MODE FOR CARRYING OUT THE INVENTION

Embodiments of the present invention will be described below in reference to the accompanying drawings.

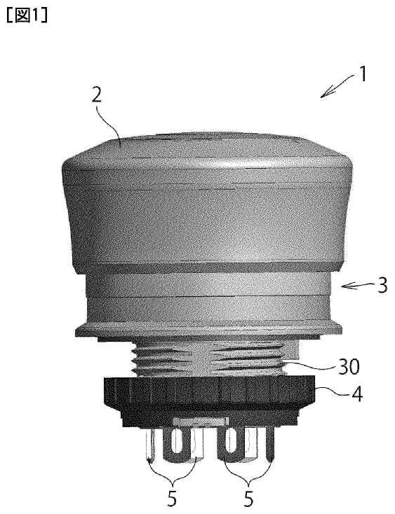

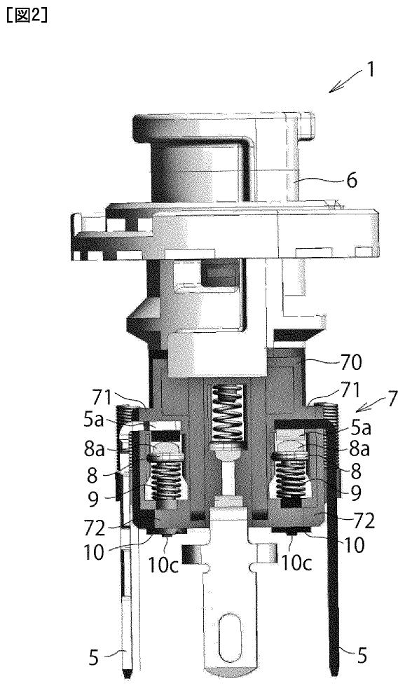

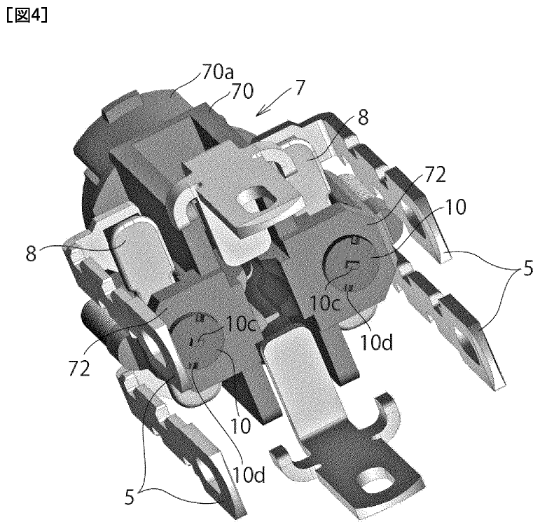

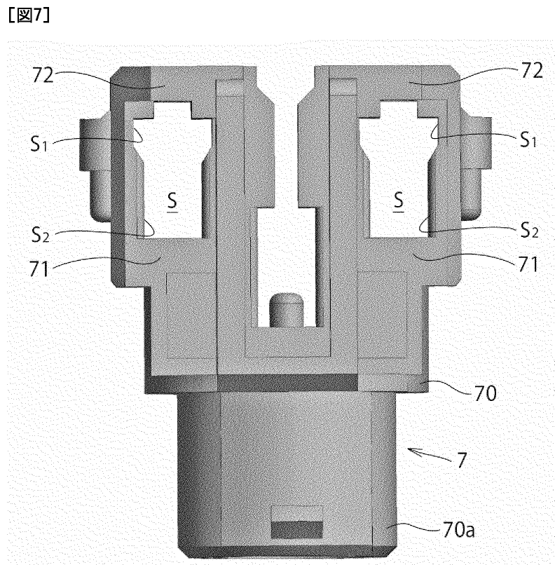

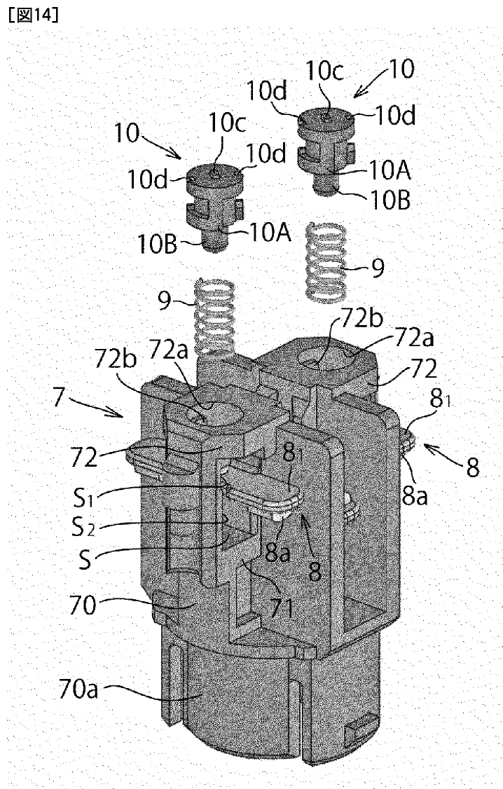

FIGS. 1 to 19 show a push button switch that employs an assembly structure of a movable terminal unit according to an embodiment of the present invention. FIG. 1 depicts an exterior appearance of the push button switch, and FIGS. 2 to 19 depict an interior structure of the push button switch. Also, FIGS. 2 to 6 show the movable terminal unit, FIGS. 7 to 9 show a housing that houses the movable terminal, FIGS. 10 to 12 show the movable terminal unit, and FIG. 13 to 19 show assembly procedures of the movable terminal unit in time series manner. Here, as a push button, an emergency stop switch is taken as an example.

As shown in FIG. 1, an emergency stop switch 1 includes a push button 2, a hold case 3 that holds the push button 2 movably in an axial direction (or up-down direction in FIG. 1), a lock nut 4 that is screwed into a male thread formed at an end portion 30 of the hold case 3, a plurality of fixed terminals 5 that extend downwardly from the bottom surface of the end portion 30 of the hold case 3, and a plurality of movable terminals (described later) that respectively correspond to the fixed terminals.

The push button 2 is push-operatable in a pressing direction (downwardly in FIG. 1) and return-operatable in a pulling direction (upwardly in FIG. 1) through an operator's manual operation. The lock nut 4 is a member for installing the emergency stop switch 1 at a panel of a machine, control equipment and the like.

FIG. 2 shows the state in which the push button 2, the hold case 3, the lock nut 4, etc. are removed from the emergency stop switch 1 of FIG. 1. As shown in FIG. 2, the emergency stop switch 1 includes a shaft portion 6 extending axially (or up-down direction in FIG. 2). The shaft portion 6 is axially movable along with the push button 2 through the operation (i.e. push-operation and return-operation) of the push button 2 (FIG. 1).

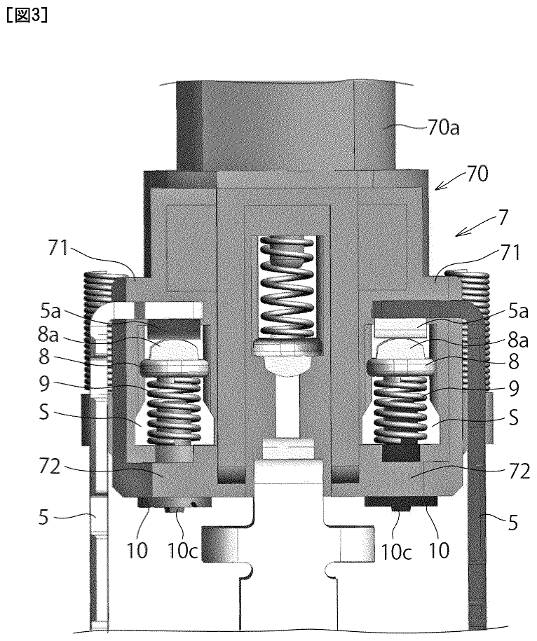

There is provided a movable terminal unit 7 below the shaft portion 6. The movable terminal unit 7 includes a housing 70. The top end 70a (FIG. 3) of the housing 70 is engaged with the shaft portion 6 and the movable terminal unit 7 is axially movable along with the movement of the shaft portion 6.

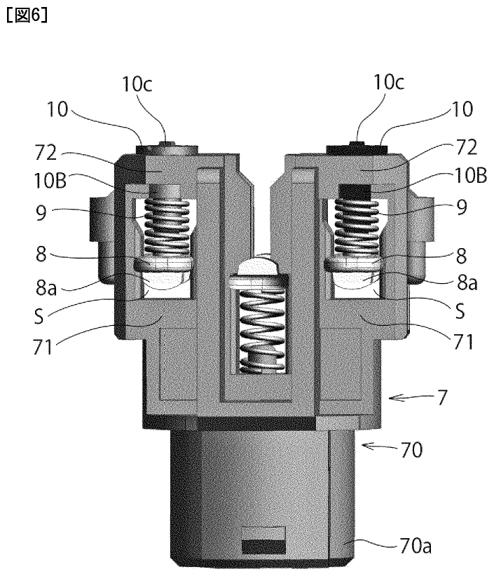

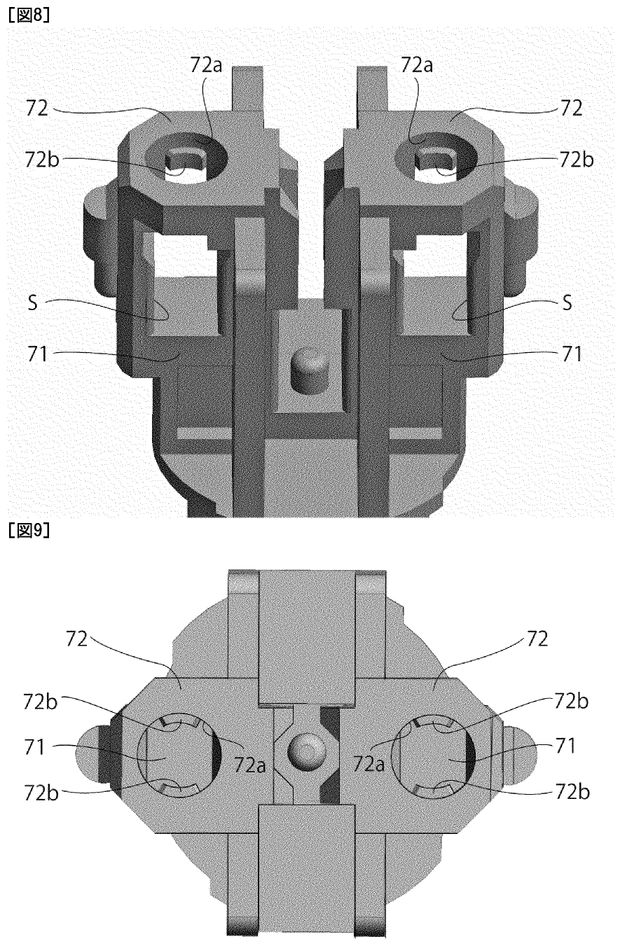

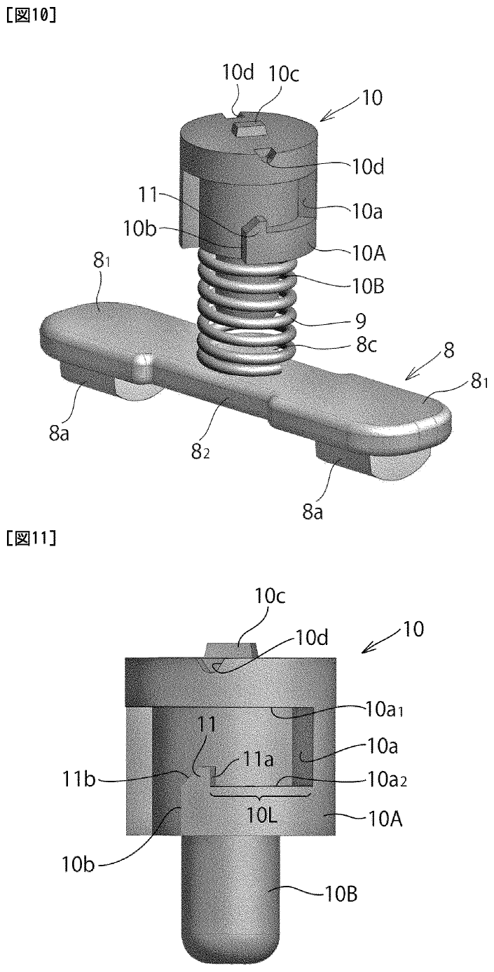

As shown in FIGS. 3, 6 and 7 (FIGS. 6 and 7 are upside down relative to FIG. 3), the housing 70 includes a first wall portion 71 and a second wall portion 72 that are oppositely disposed in the up-down direction with a predetermined distance therebetween. These wall portions 71, 72 form a pair of housing spaces (or housing portions) S that extend in the up-down direction. In the respective housing spaces S, a movable terminal 8 and a coil spring (or biasing means) 9 that biases the movable terminal 8 toward the first wall portion 71 are respectively housed. As shown in FIG. 8, at the second wall portion 72, a circular through hole (opening) 72a is formed that passes through the second wall portion 72 in the up-down direction. The through hole 72a is sized so that the coil spring 9 can pass through. At a circular inner circumferential surface of the through hole 72a, an engagement protrusion 72b is provided that extends circumferentially in an arc-shape along the inner circumferential surface. As shown in FIG. 9, the engagement protrusion 72b is formed of a pair of engagement protrusions that are oppositely disposed at the circular inner circumferential surface of the through hole 72 a (that is, spaced 180 degrees circumferentially apart from each other).

At the through hole 72a of the second wall portion 72, a pressing member 10 is provided that compressive-deforms the coil spring 9 in the housing space S and that holds the coil spring 9 in its compressive state (see FIGS. 3 to 6). As shown in FIGS. 10 to 12, the pressing member 10 includes a generally cylindrical large-diameter portion 10A that is disposed at an end of the pressing member 10 and that is to be fitted in the through hole 72a, and a cylindrical shaft portion 10B that is disposed at the other end of the pressing member 10 and that has a small-diameter smaller than the large-diameter portion 10A. The shaft portion 10B extends through the inner circumferential space of the coil spring 9 to hold a front-end portion (i.e. an end on the side of the pressing member 10) of the coil spring 9 of the movable terminal unit 7.

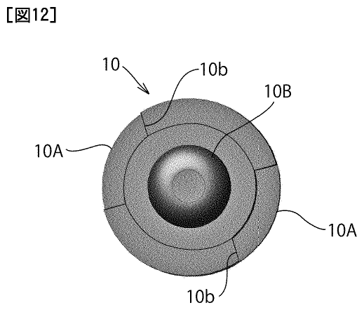

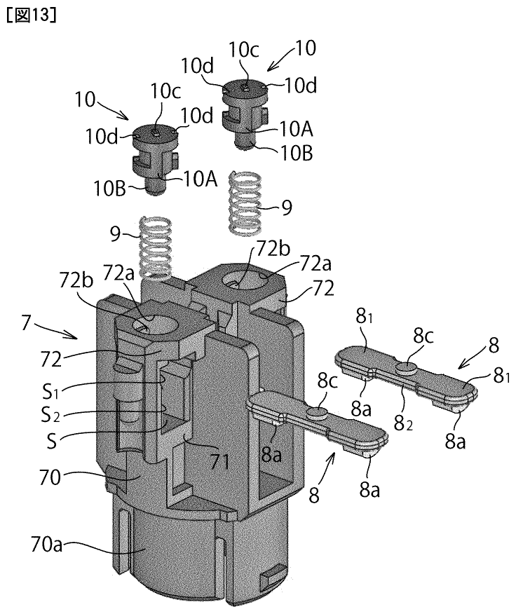

The circular outer circumferential surface of the large-diameter portion 10A is sized to slide circumferentially along the circular inner circumferential surface of the through hole 72a. At the circular outer circumferential surface of the large-diameter portion 10A, an engagement recess 10a is formed that extends circumferentially along the outer circumferential surface in an arc-shape and that is engageable with the engagement protrusion 72b at the inner circumferential surface of the through hole 72a. As shown in FIGS. 11 and 12, the engagement recess 10a is formed of a pair of engagement recesses that are disposed at opposite positions (i.e. at positions circumferentially spaced generally 180 degrees away from each other) on the circular outer circumferential surface of the large-diameter portion 10A. By the engagement of the respective engagement protrusions 72b of the through hole 72a of the second wall portion 72 with the respectively corresponding engagement recesses 10a of the large-diameter portion 10A of the pressing member 10, the pressing members 10 are held in the through hole 72a.

At a lower-side end of the large-diameter portion 10A, there is formed an insertion slot (or opening) 10b that extends axially to provide a connection with the engagement recess 10a and that allows an entry of the engagement protrusion 72b at the inner circumferential surface of the through hole 72a. The insertion slot 10b and the engagement recess 10a forms a concave portion of an inverted-V shape as viewed from the front side of the large-diameter portion 10A. At an opening end (or a left-side end in FIG. 11) of the engagement recess 10a, a protruding portion 11 is provided that protrudes into the engagement recess 10a. The protruding portion 11 is generally trapezoidal-shaped or triangular-shaped and includes an upstanding wall 11a that extends axially upwardly (or in the upward direction in FIG. 11) and an inclined wall portion 11b that extends diagonally relative to the axial direction.

The upstanding wall 11a defines a circumferential length 10L of the engagement recess 10a and functions as a circumferential-movement restrictive portion that restricts the engagement protrusion 72b from moving circumferentially in the engagement recess 10a in the state of engagement of the engagement protrusion 72b of the through hole 72a with the engagement recess 10a. Also, the upper-side wall portion 10ₐ_{₁} and the lower-side wall portion 10ₐ_{₂} that define the engagement recess 10a function as an axial-movement restrictive portion that restricts the engagement protrusion 72b from moving axially (or in the up-down direction in FIG. 11) in the engagement recess 10a in the state of engagement of the engagement protrusion 72b of the through hole 72a with the engagement recess 10a.

As shown in FIG. 10, a projection (or catch portion) 10c is provided at the center of the top surface of the large-diameter portion 10A of the pressing member 10. The projection 10c has a cuboid-shape, for example. When fitting the pressing member 10 in the through hole 72a, the projection 10c is adapted to be caught and rotated by the distal end of a dedicated tool (or rotating tool), for example, in order to rotate the pressing member 10 around its central axis in the through hole 72a. Additionally, when forming the pressing member 10, a runner portion corresponding to the dedicated tool may be integrally formed with the pressing member 10. Thereby, the runner portion is operated as a handle and by doing so, the pressing member 10 is installed at the through hole 72a. Thereafter, the runner portion may be cut in the vicinity of the top surface of the large-diameter portion 10A. In this case, by making a cross-sectional area of the runner portion minimum at a cutting position, cutting of the runner portion is facilitated.

A notch 10d is formed at the outer circumferential edge of the top surface of the large-diameter portion 10A of the pressing member 10. In this exemplification, the notch 10d is formed of two notches that are spaced circumferentially at substantially equal spacing. The notch 10d is used for rotating the pressing member 10 in the through hole 72a with the distal end of a tool engaged with the notch 10d when removing the pressing member 10 from the through hole 72a after an assembly of the movable terminal unit 7.

As shown in FIG. 13, a blown-up perspective view of the movable terminal unit 7, the movable terminal 8 is a generally rectangular-shaped member that extends longitudinally and includes a movable contact 8a at both ends. At the longitudinal center of the movable terminal 8, a protrusion 8c is provided. The protrusion 8c is a portion for holding the bottom end of the coil spring 9 from the inner circumferential side of the coil spring 9 at the time of assembly of the movable terminal unit 7 (see FIG. 10). The upper end of the coil spring 9, as shown in FIG. 10, is held by the shaft portion 10B of the pressing member 10 from the inner circumferential side of the coil spring 9. The axial gap defined by the protrusion 8c and the shaft portion 10B is a maximum movement amount of the movable terminal 8 (that is, a maximum movable stroke, in other words, a maximum compressible amount of the coil spring 9). The shaft portion 10B of the pressing member 10 regulates the movement amount of the movable terminal 8. In addition, the practical movement amount of the movable terminal 8 is set at a value smaller than the maximum movement amount.

As shown in FIG. 10, a generally longitudinal center of the movable terminal 8 has a narrow-width portion 82 that is narrower than a wide-width portion 81 at the longitudinally opposite ends. On the other hand, as shown in FIG. 7, the housing space S of the movable terminal 8 is open to its side (i.e. into and out of the page), and formed of a wide-width portion S₁ disposed on the side of the second wall portion 72 and a narrow-width portion S₂ disposed on the side of the first wall portion 71. The wide-width portion S₁ is sized so that the wide-width portion 81 of the movable terminal 8 can be inserted from the side (e.g. out of the page of FIG. 7). The narrow-width portion S₂ is sized so that the narrow-width portion 8₂ of the movable terminal 8 can be inserted in the up-down direction (i.e. up-down direction in FIG. 7). The wide-width portion S₁ and the narrow-width portion S₂ are interconnected to each other through an inclined surface.

As shown in FIG. 3, the fixed terminal 5 is formed of a pair of conductive members that are respectively bent in a general L-shape and is fixed to the hold case 3 (FIG. 1). A fixed contact 5a is fitted to the distal end of the fixed terminal 5. The fixed contact 5a is disposed opposite the corresponding movable contact 8a in the up-down direction.

In the state in which the push button 2 is not pressed, due to the action of the elastic repulsion of the coil spring 9, the movable contact 8a is in elastically contact with the corresponding fixed contact 5a (see FIG. 3) to impart a predetermined contact pressure to the fixed contact 5a. When the push button 2 is pressed (or press-operated), the movable contact unit 7 moves in a pressing direction of the push button 2 (i.e. downwardly in FIG. 3) along with the shaft portion 6. The movable terminal 8 thus moves in the same direction, and as a result, the movable contact 8a moves away from the fixed contact 5a. Also, at the time of a return operation of the push button 2 after the press-operation of the press button 2, when moving the push button 2 in a pulling direction (i.e. upwardly in FIG. 3), the movable contact unit 7 moves in the same direction along with the shaft portion 6. The movable terminal 8 thus moves in the same direction and as a result, the movable contact 8a moves toward and comes into contact with the fixed contact 5. In this way, the movable contact 8 is adapted to move toward and away from the fixed contact 5. Thereby, the movable contact 8 is contactable and separatable relative to the fixed contact 5a.

Then, the assembly procedures of the above-mentioned movable terminal unit 7 will be explained in reference to FIGS. 13 to 19.

When assembling the movable terminal unit 7, as shown in FIG. 13, firstly, the housing 70 is set on a base surface of an automatic assembly machine (not shown). At this time, the housing 70 is disposed with a through hole 72a facing up.

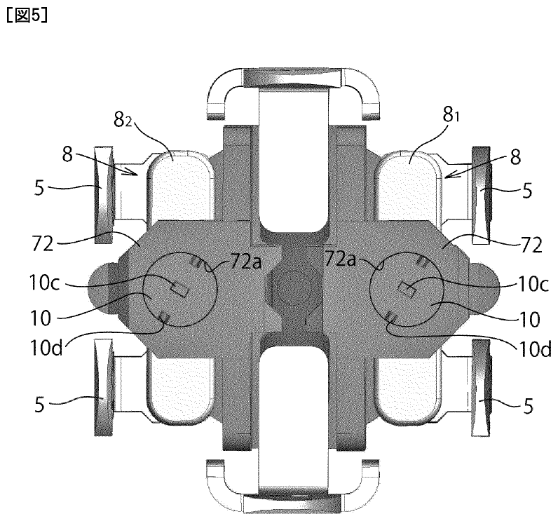

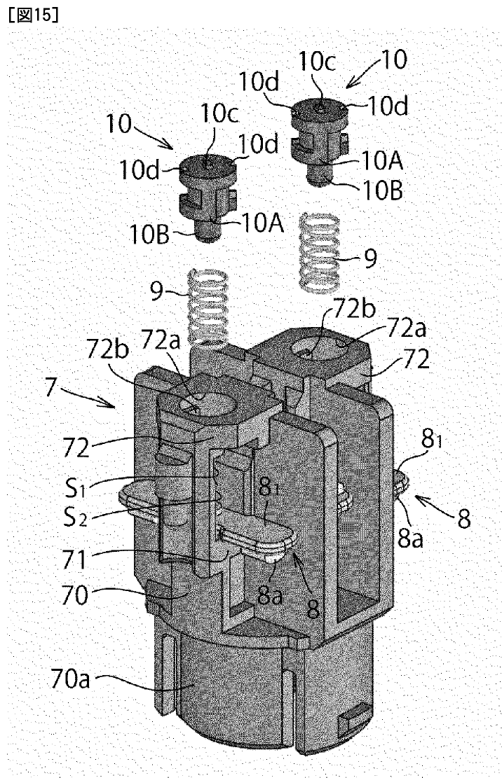

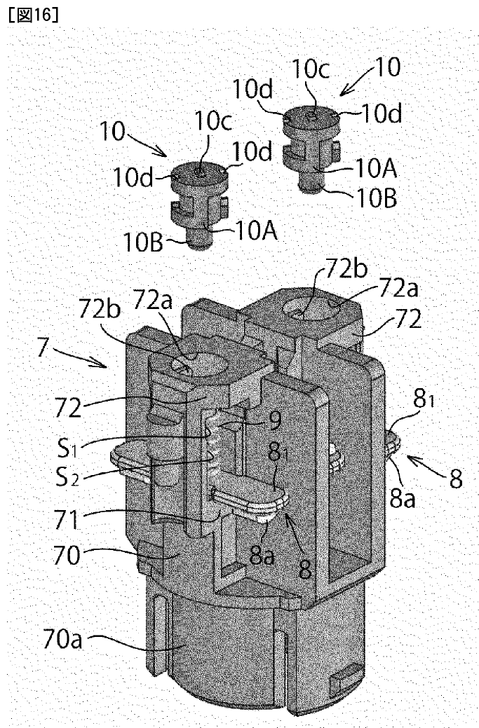

Secondly, as shown in FIG. 14, the movable terminal 8 is inserted into the wide-width portion Si from the side of the housing space S and the central narrow-width portion 82 (FIG. 13) of the movable terminal 8 is positioned at the wide-width portion S₁. From this state, as shown in FIG. 15, the movable terminal 8 is moved downwardly (i.e. toward the first wall portion 71) to contact the first wall portion 71. At this juncture, the narrow-width portion 82 at the center of the movable terminal 8 is sandwiched by the opposite ends of the narrow-width portion S₂ of the housing space S. The wide-width portions 8₁ at both ends of the movable terminal 8 are disposed on opposite sides of the narrow-width portion S₂ of the housing space S (see FIG. 5).

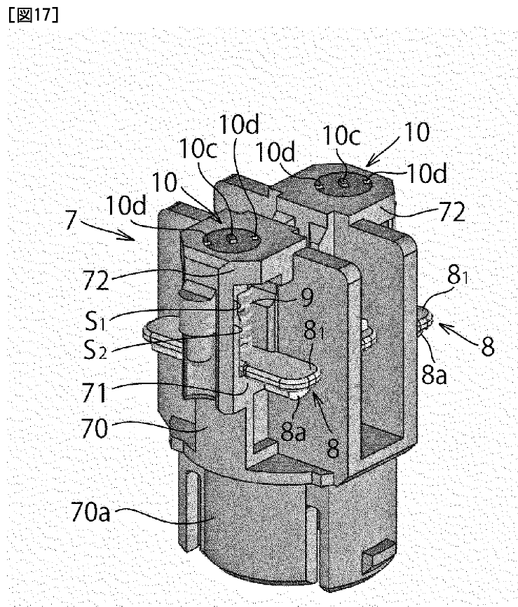

Thirdly, as shown in FIG. 16, the coil spring 9 is inserted into the housing portion S from the through hole 72a to contact the movable terminal 8. At this time, the bottom end of the coil spring 9 is supported from the inner-circumferential side by the central protrusion 8c (FIG. 13) of the movable terminal 8 (see FIGS. 3, 10).

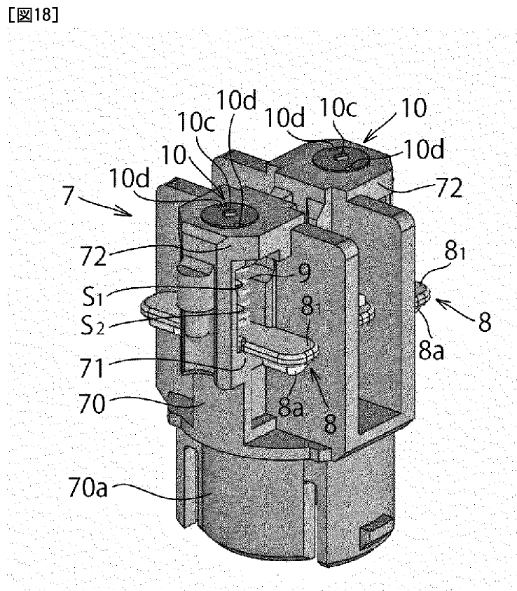

Fourthly, as shown in FIG. 17, the pressing member 10 is inserted into the through hole 72a. FIG. 17 shows the state in which the insertion slot 10b (FIG. 10) of the large-diameter portion 10A of the pressing member 10 has passed through the engagement protrusion 72b (FIG. 8) of the through hole 72a and the pressing portion 10 is thus inserted and housed in the through hole 72a. At the time of insertion, the large-diameter portion 10A of the pressing member 10 comes into contact with and presses the coil spring 9 in the housing portion S to compressive-deform the coil spring 9. The upper portion of the coil spring 9 is supported from the inner-circumferential side by the shaft portion 10B of the pressing member 10 (see FIGS. 3, 10).

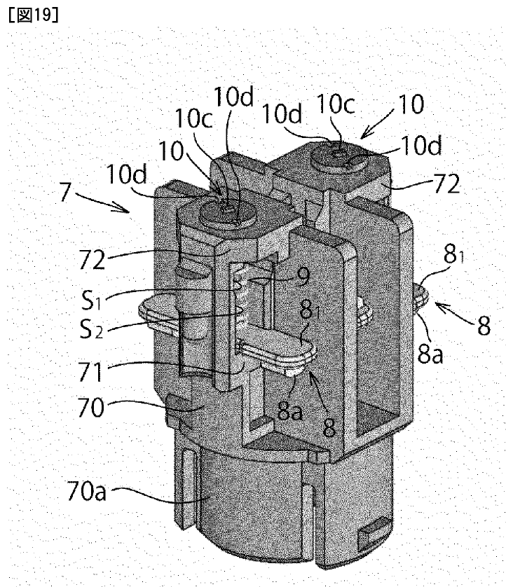

From this state, as shown in FIG. 18, the pressing member 10 is rotated in the rightward rotational direction (i.e. in the clockwise direction). At this juncture, the outer circumferential surface of the large-diameter portion 10A of the pressing member 10 slides circumferentially along the inner circumferential surface of the through hole 72a, and the engagement protrusion 72b (FIG. 8) of the through hole 72a climbs over the protrusion 11 (FIG. 11) of the large-diameter portion 10A of the pressing member 10 to make an engagement with the engagement recess 10a. When the engagement protrusion 72b climbs over the protrusion 11 of the pressing member 10, the inclined wall surface 11b of the protrusion 11 causes the engagement protrusion 72b to move toward the engagement recess 10a smoothly. In addition, as can be seen by comparing FIG. 17 with FIG. 18, the rotated state of the pressing member 10 is shown by the change of position of the notch 10d of the large-diameter portion 10A of the pressing member 10.

Then, when the pressing force applied to the pressing member 10 is removed, due to the action of the elastic repulsion of the coil spring 9, the pressing member 10 moves a bit toward the outside (i.e. upwardly in FIG. 18) of the through hole 72a to be held in the through hole 72a. At this juncture, as shown in FIG. 19, the top surface of the pressing member 10 protrudes a bit from the upper surface of the second wall portion 72. In such a manner, the assembly of the movable terminal unit 7 is completed.

In the state of FIG. 19, the engagement protrusion 72b of the through hole 72a is in pressure-contact with the lower-side wall portion 10ₐ_{₂} in the engagement recess 10a (FIG. 11). Therefore, from this state, when one tries to rotate the pressing member 10 in the counterclockwise direction, the engagement protrusion 72b interferes with the upstanding wall 11a of the protrusion 11 (FIG. 11) of the pressing member 10, thus preventing the rotation of the pressing member 10 in a removing direction. In order to remove the pressing member 10 from the state shown in FIG. 19, all one has to do is apply a pressing force to the pressing member 10 against the elastic repulsion of the coil spring 9, with the engagement protrusion 72b transferred to the upper-side wall portion 10ₐ_{₁} (FIG. 11) in the engagement recess 10a, rotate the pressing member 10 in the counterclockwise direction to move the pressing member 10 at the position of the insertion slot 10b, and thereafter remove the pressing force relative to the pressing member 10.

In above-mentioned embodiment, the movable terminal 8 and the coil spring 9 are housed in the housing space S defined by the first and second wall portions 71, 72, the pressing member 10 is disposed at the through hole 72a of the second wall portion 72, the outer circumferential surface of the large-diameter portion 10A of the pressing member 10 is in circumferentially sliding-contact with the circular inner circumferential surface of the through hole 72a, and the engagement protrusion 72b at the circular inner circumferential surface of the through hole 72a is in engagement with the engagement recess 10a at the outer circumferential surface of the large-diameter portion 10A of the pressing member 10, such that thereby the pressing member 10 is supported by the through hole 72a. Therefore, when fitting the pressing member 10 in the through hole 72a by means of the engagement protrusion 72b and the engagement recess 10a, all one has to do is cause the outer circumferential surface of the pressing member 10 to slide circumferentially along the circular inner circumferential surface of the through hole 72a, thereby improving an ease of assembly.

In the assembly procedures of the above-mentioned movable terminal unit 7, when inserting the pressing member 10 into the through hole 72a (see FIGS. 16, 17), the insertion slot 10b of the pressing member 10 does not need to be aligned with the engagement protrusion 72b of the through hole 72a. Even in the state that the insertion slot 10b of the pressing member 10 is not aligned with the engagement protrusion 72b of the through hole 72a, all one has to do is press and slowly rotate the pressing member 10 in the through hole 72a clockwise or counterclockwise when inserting the pressing member 10 into the through hole 72a. Thereby, during rotation of the pressing member 10, when the insertion slot 10b of the pressing member 10 is aligned with the engagement portion 72b of the through hole 72a, the engagement protrusion 72b of the through hole 72a is inserted through the insertion slot 10b of the pressing member 10 and the pressing member 10 is thus inserted into the through hole 72a. Also, after insertion of the pressing member 10 into the through hole 72a, by rotating the pressing member 10 clockwise with the pressing member 10 pressed by a pressing force, the engagement protrusion 72 of the through hole 72a comes into engagement with the engagement recess 10a of the pressing member 10.

Consequently, according to the present invention, when fitting the pressing member 10 in the through hole 72a, one has only to push the pressing member 10 in the through hole 72a and rotate the pressing member 10 clockwise in the through hole 72a, thus eliminating the need for a troublesome positioning between the engagement portions.

### First Alternative Embodiment

In the above-mentioned embodiment, an example was shown in which the engagement projection 72b is formed at the inner circumferential surface of the through hole 72a of the wall portion 72 of the housing 70 and the engagement recess 10a that the engagement projection 72b engages with is formed at the outer circumferential surface of the large-diameter portion 10A of the pressing member 10, but the application of the present invention is not restricted to such an example.

In contrast to the above-mentioned embodiment, the engagement projection may be formed at the outer circumferential surface of the large-diameter portion 10A of the pressing member 10 and the engagement recess that the engagement projection engages with may be formed at the inner circumferential surface of the through hole 72a of the second wall portion 72. In this case, at the through hole 72a, there is formed an insertion slot that extends axially to permit an insertion of the engagement projection of the pressing member 10 and that provides a connection with the engagement recess.

### Second Alternative Embodiment

In the above-mentioned embodiment, an example was shown in which the engagement projection 72b of the through hole 72a is provided at two positions oppositely disposed to each other at the inner circumferential surface and the engagement recess 10a of the pressing member 10 is formed at two positions oppositely disposed to each other at the outer circumferential surface. However, these engagement projection 72b and the engagement recess 10a may be disposed at three or more positions that are spaced at a substantially equal distance in the circumferential direction.

### Third Alternative Embodiment

In the above-mentioned embodiment, an example was shown in which the engagement projection 72b is prevented from falling off relative to the engagement recess 10a in the circumferential direction and the axial direction by forming the circular engagement projection 72b at the inner circumferential surface of the through hole 72a and forming the engagement recess 10a that the engagement projection 72b is engageable with at the outer circumferential surface of the large-diameter portion 10A of the pressing member 10, but the application of the present invention is not restricted to such an example.

A female screw extending in a spiral may be formed at the inner circumferential surface of the through hole 72a and a male screw screwed into the female screw may be formed at the outer circumferential surface of the large-diameter portion 10A of the pressing member 10. After the large-diameter portion 10A of the pressing member 10 is fastened to the through hole 72a by means of these screws, the pressing member 10 may be fixed to the through hole 72a by adhesive such as a screw-locking adhesive.

### Fourth Alterenative Embodiment

In the above-mentioned embodiment, an example was shown in which the housing space S is defined by the first and second wall portions 71, 72, but the application of the present invention is not restricted to such an example. By omitting the second wall portion 72, the housing space S may be a space that opens to the upper side (that is, open to one-end side).

Although not shown in a figure, a circular inner circumferential surface is formed at an opening on one-end side (see the concave groove (3) in FIG. 1 of Japanese utility model registration application publication No. 1977-26171), a pair of engagement projections 72b similar to those in the above-mentioned embodiment are provided at the inner circumferential surface, and the outer circumferential surface of the large-diameter portion 10A of the pressing member 10 is in circumferentially sliding-contact with the circular inner circumferential surface at the opening on one-end side. Through engagement of the engagement projection 72b with the engagement recess 10a of the large-diameter portion 10A, the pressing member 10 is supported at the opening. Additionally, in this case, insertion of the movable terminal 8 into the housing space S is conducted from the opening on one-side, for example.

In this case as well, when fitting the pressing member 10 in the opening on one-side, one has only to press the pressing member 10 into the opening on one-side and make the pressing member 10 circumferentially sliding-contact with the circular inner circumferential surface of the opening, thus eliminating the need for a troublesome positioning between the engagement portions, thus improving an ease of assembly.

### Fifth Alternative Embodiment

In the above-mentioned embodiment, an example was shown in which the protrusion (i.e. catch portion) 10c is provided at the center of the top surface of the large-diameter portion 10A of the pressing member 10, but the application of the present invention is not restricted to such an embodiment. In lieu of the protrusion 10c, an engagement recess (i.e. engagement portion) (not shown) may be provided at the center of the top surface. In this case, by making the engagement recess a cross recess, a hexagon socket and the like, for example, when fitting the pressing member 10 in the through hole 72a, a general-purpose tool such as Phillips head screwdriver, hex key (hex wrench) and the like, for example, which has a distal-end shape corresponding to the engagement recess, can be used.

### Other Alternative Embodiment

The above-mentioned embodiment and respective alternative embodiments should be considered in all respects only as illustrative and not restrictive. Those skilled in the art to which the invention pertains may make various modifications and other embodiments employing the principles of the present invention without departing from its spirit or essential characteristics particularly upon considering the foregoing teachings, even if there are no explicit explanations in the description.

### Applicable Examples and Other Applicable Examples

As a preferred applicable example of the assembly structure of the movable terminal unit of the present invention, an emergency stop switch was taken for example, but the application of the present invention is not restricted to the emergency stop switch and the present invention is also applicable to a push button switch other than the emergency stop switch.

Also, the emergency stop switch employing the present invention is provided at mechanical equipment used in a factory or its control equipment and various controllers such as a teaching device connected to the control equipment. During operation of the emergency stop switch, it makes an emergency-stop the mechanical equipment.

### INDUSTRIAL APPLICABILITY

The present invention is of use to an assembly structure of a movable terminal unit and suitable especially to a structure for improving an ease of assembly.

### DESCRIPTION OF REFERENCE NUMERALS

1: emergency stop switch (push button switch)
2: push button
5: fixed terminal
7: movable terminal unit
71: first wall portion
72: second wall portion
72a: through hole
72b: engagement protrusion (engagement portion)
8: movable terminal
9: coil spring (biasing member)
10: pressing member
10a: engagement recess (engagement portion)
10ₐ_{₁}: upper-side wall portion (axial movement restrictive portion)
10ₐ_{₂}: lower-side wall portion (axial movement restrictive portion) p1 10b: insertion slot
10c: projection (catch portion)
10B: shaft portion
11: protruding portion (circumferential movement restrictive portion)
S: housing space (housing portion)

1. An assembly structure of a movable terminal unit, comprising:
a housing space is defined by a first wall portion and a second wall portion that are oppositely disposed across a predetermined distance,
wherein the movable terminal is housed in said housing space and a biasing member that biases said movable terminal toward said first wall portion is disposed in said housing space,
wherein said second wall portion is formed with a through hole that said biasing member can pass through, and a pressing member that compressive-deforms said biasing member is disposed in said through hole, and
wherein said pressing member includes an outer circumferential surface that slides circumferentially along a circular inner circumferential surface of said through hole, and said pressing member is held at said through hole through an engagement portion provided at said inner and outer circumferential surfaces.

2. An assembly structure of a movable terminal unit, comprising:
a housing portion that has an opening on one-end side thereof, wherein a movable terminal is housed in said housing portion and a biasing member that biases said movable terminal toward the other-end side of the housing portion is disposed in said housing portion,
wherein said opening on one-end side of said housing portion is sized so that said biasing member can pass through and a pressing member that compressive-deforms said biasing member is disposed in said opening, and
wherein said pressing member includes an outer circumferential surface that makes a circumferential sliding-contact with a circular inner circumferential surface of said opening, and said pressing member is held at said opening through an engagement portion provided at said inner and outer circumferential surfaces.

3. The assembly structure of the movable terminal unit according to claim 1, wherein said engagement portion comprises an engagement protrusion that extends circumferentially at either one of said inner circumferential surface or said outer circumferential surface of said pressing member and an engagement recess that extends circumferentially and that is engageable with said engagement protrusion at either the other of said inner circumferential surface or said outer circumferential surface of said pressing member.

4. The assembly structure of the movable terminal unit according to claim 3, wherein said engagement recess comprises an insertion slot that allows an insertion of said engagement protrusion, a circumferential movement restrictive portion that restricts said engagement protrusion from moving circumferentially in said engagement recess in an engagement state of said engagement protrusion, and a axial movement restrictive portion that restricts said engagement protrusion from moving axially in said engagement recess.

5. The assembly structure of the movable terminal unit according to claim 1, wherein said engagement portion is formed of a plurality of engagement portions that are spaced at a substantially equal interval along a circumferential direction.

6. The assembly structure of the movable terminal unit according to claim 1, wherein said pressing member includes a catch portion for rotating said pressing member around a central axis thereof through a rotary tool.

7. The assembly structure of the movable terminal unit according to claim 1, wherein said biasing member is a coil spring, and said pressing member includes a shaft portion that extends in an inside space of said coil spring, such that thereby said shaft portion restricts an amount of movement of said movable terminal.

8. A push button switch having said assembly structure of said movable terminal unit according to claim 1, wherein said movable terminal is movable along with a push button and a movement of said push button causes said movable terminal to move toward and away from said fixed terminal.

9. The push button switch according to claim 8, wherein said push button switch is an emergency stop switch.

10. A controller that incorporates said push button switch according to claim 8.

11. An assembly method of a movable terminal unit, said movable terminal unit including a movable terminal, a biasing member that biases said movable terminal, and a pressing member of said biasing member, said assembly method is for housing and assembling said movable terminal unit in a housing portion that is open at its one end and to its side,
said assembly method comprising:
inserting said movable terminal into said housing portion from a one-end opening or a side opening of said housing portion and disposing said movable terminal at its other end of said housing portion;
inserting said biasing member into said housing portion from said one-end opening of said housing portion and making said biasing member contact with said movable terminal;
disposing said pressing member at said one-end opening of said housing portion and making said pressing member contact with said biasing member to press and compressive-deform said biasing member; and
sliding said pressing member circumferentially along a circular inner circumferential surface of said one-end opening of said housing portion, whereby said pressing member is held at said one-end opening of said housing portion through an engagement portion that is provided at said inner circumferential surface of said one-end opening of said housing portion and at an outer circumferential surface of said pressing member that corresponds to said inner circumferential surface of said one-end opening of said housing portion.

12. The assembly structure of the movable terminal unit according to claim 2, wherein said engagement portion comprises an engagement protrusion that extends circumferentially at either one of said inner circumferential surface or said outer circumferential surface of said pressing member and an engagement recess that extends circumferentially and that is engageable with said engagement protrusion at either the other of said inner circumferential surface or said outer circumferential surface of said pressing member.

13. The assembly structure of the movable terminal unit according to claim 12, wherein said engagement recess comprises an insertion slot that allows an insertion of said engagement protrusion, a circumferential movement restrictive portion that restricts said engagement protrusion from moving circumferentially in said engagement recess in an engagement state of said engagement protrusion, and a axial movement restrictive portion that restricts said engagement protrusion from moving axially in said engagement recess.

14. The assembly structure of the movable terminal unit according to claim 2, wherein said engagement portion is formed of a plurality of engagement portions that are spaced at a substantially equal interval along a circumferential direction.

15. The assembly structure of the movable terminal unit according to claim 2, wherein said pressing member includes a catch portion for rotating said pressing member around a central axis thereof through a rotary tool.

16. The assembly structure of the movable terminal unit according to claim 2, wherein said biasing member is a coil spring, and said pressing member includes a shaft portion that extends in an inside space of said coil spring, such that thereby said shaft portion restricts an amount of movement of said movable terminal.

17. A push button switch having said assembly structure of said movable terminal unit according to claim 2, wherein said movable terminal is movable along with a push button and a movement of said push button causes said movable terminal to move toward and away from said fixed terminal.

18. The push button switch according to claim 17, wherein said push button switch is an emergency stop switch.

19. A controller that incorporates said push button switch according to claim 17.
